(19) United States
(12) Patent Application Publication
(10) Pub. No.: US 2022/0275794 A1
(43) Pub. Date: Sep. 1, 2022

(54) HYDRAULIC FRACTURING PUMP APPARATUS AND METHOD FOR DRIVING SAME

(71) Applicant: Voith Patent GmbH, Heidenheim (DE)

(72) Inventor: Thomas Täuber, Crailsheim (DE)

(73) Assignee: Voith Patent GmbH, Heidenheim (DE)

(21) Appl. No.: 17/748,635

(22) Filed: May 19, 2022

Related U.S. Application Data
(63) Continuation of application No. PCT/EP2020/074745, filed on Sep. 4, 2020.

(30) Foreign Application Priority Data
Nov. 19, 2019 (DE) 10 2019 131 129.2

(51) Int. Cl. F04B 17/00; E21B 43/26; F04B 49/20

(52) U.S. Cl. CPC F04B 17/00; E21B 43/2607; F04B 49/20

(57) ABSTRACT

A hydraulic fracturing pump apparatus includes: at least one gas turbine forming a prime mover and including at least one of a single-shaft gas turbine and a multi-shaft gas turbine; at least one fracturing pump which is in a drive connection with the at least one gas turbine to be driven by way of the at least one gas turbine and which is configured for pumping a pressure medium into a rock layer; and a hydrodynamic torque converter in the drive connection, the hydrodynamic torque converter including an input shaft, an output shaft, and a hydrodynamic converter, the input shaft being switchable via the hydrodynamic converter into a hydrodynamic drive connection with the output shaft.

### CROSS REFERENCE TO RELATED APPLICATIONS

This is a continuation of PCT application no. PCT/EP2020/074745, entitled “HYDRAULIC FRACTURING PUMP APPARATUS AND METHOD FOR DRIVING SAME”, filed Sep. 4, 2020, which is incorporated herein by reference. PCT application no. PCT/EP2020/074745 claims priority to German patent application no. 10 2019 131 129.2, filed Nov. 19, 2019, which is incorporated herein by reference.

### BACKGROUND OF THE INVENTION

### 1. Field of the Invention

The present invention relates to a hydraulic fracturing pump apparatus including at last one single-shaft or multi-shaft gas turbine as a prime mover, and at least one fracturing pump which is in driving connection with the at least one gas turbine to be driven by way of the at least one gas turbine and which is arranged to pump a pressure medium into a rock layer. The present invention also relates to a method to drive a hydraulic fracturing pump apparatus.

### 2. Description of the Related Art

Fracturing pump apparatuses have a prime mover and a pump, wherein the pump pumps a pressure medium at very high pressure into a rock layer. Fracturing is also referred to as fracking and accordingly the pump is known as fracking pump. During fracking, the so-called fracfluid is pressed under high pressure of typically several hundred bar through a bore into the geological horizon where extraction is to take place. Fracfluid, herein referred to as a pressure medium, is generally water which, most of the time, is mixed with supporting agents, for example quartz sand and thickening agents. As a general rule, several fracturing pumps which are connected with different bore holes are used simultaneously. At least one fracturing pump is provided for each bore hole. The pressure of the medium pressure to be provided by the respective fracturing pump is borehole-dependent and the necessary volume flow that is generated by the corresponding fracturing pump is speed-dependent.

Various prime movers have already been proposed to drive hydraulic fracturing pumps. For example, WO 2015/011223 A2 discloses a hybrid drive with a gas engine and an electric motor.

In practice it was found that gas turbines are especially suitable as a prime mover for fracturing pumps. Both, single shaft gas turbines, whose turbine runner is rigidly coupled via a common shaft with the compressor impeller, as well as two-shaft gas turbines, which have a high pressure turbine runner that is rigidly coupled via a first shaft with the compressor impeller and a low pressure turbine runner which can be driven at a different speed than the high pressure turbine runner since it has a separate shaft and is charged only with the exhaust gas flow from the high pressure turbine for its drive, are used.

EP 2 894 315 A1 moreover proposes a two-shaft gas turbine, wherein the high pressure turbine shaft can additionally be coupled via a coupling with the low pressure turbine shaft, wherein such a gas turbine can also be used for the current invention.

Single shaft turbines operate at a constant speed in nominal operation. These single shaft gas turbines can only be started at a low load and can be ramped up to a predetermined rated speed, before they can then drive the prime mover with a higher load at the specified rated speed. In the case of two-shaft turbines, the speed in nominal operation is variably adjustable, however, the speed control range is typically limited, for example between 70 and 100 percent of the maximum speed. However, two-shaft gas turbines are generally larger, heavier and more expensive than single shaft gas turbines. Thus, two-shaft gas turbines cannot be mounted on a readily movable device—for example a truck trailer—together with a fracturing pump, because of insufficient availability of installation space.

When driving fracturing pumps, speed adjustability is necessary in nominal operation in most cases. Because of this two-shaft gas turbines are traditionally used, or other prime movers as described for example in WO 2015/011223 A2. Even with two-shaft gas turbines with a speed control range, the limited control range may not be sufficient for all desired operating points.

What is needed in the art is a hydraulic fracturing pump apparatus which permits the use of a single-shaft or multi-shaft gas turbine and at the same time a wide speed control range of the fracturing pump.

### SUMMARY OF THE INVENTION

The present invention provides a hydraulic fracturing pump apparatus. Moreover, a method for controlling a hydraulic fracturing pump apparatus is specified which ensures an especially high level of efficiency.

The hydraulic fracturing pump apparatus according to the present invention includes at least one single-shaft or multi-shaft gas turbine as a prime mover, and at least one fracturing pump which is in driving connection with the at least one gas turbine to be driven by way of the at least one gas turbine and which is arranged to pump a pressure medium into a rock layer.

According to the present invention a hydrodynamic torque converter is provided in the drive connection, said hydrodynamic torque converter having an input shaft, an output shaft, a hydrodynamic converter and optionally a switchable lock-up clutch, wherein the input shaft is switchable via the hydrodynamic converter into a hydrodynamic drive connection with the output shaft and, if provided, is switchable via the lock-up clutch into a purely mechanical drive connection with the output shaft. The hydrodynamic torque converter thus has optionally a hydrodynamic power branch and also a purely mechanical power branch.

The hydrodynamic converter makes a load-free startup of the gas turbine possible, which is especially important with a single-shaft gas turbine as a prime mover. Accordingly, the working chamber of the hydrodynamic converter can be emptied for start up, at least to a great extent of working medium so that the prime mover can be ramped up substantially load-free to its nominal speed, and the working chamber of the converter can subsequently be filled in order to transmit the desired drive torque from the prime mover to the fracturing pump. Accordingly, the hydrodynamic converter is designed as a fill-and-drain torque converter.

If the hydrodynamic converter is used with a multi-shaft gas turbine as a prime mover, the hydrodynamic converter enables speed adjustability of the fracturing pump apparatus, which cannot be provided by the gas turbine alone.

By arranging the hydrodynamic torque converter with one hydrodynamic power branch and a parallel purely mechanical power branch it is possible to regulate or control the speed of at least one fracturing pump over a comparatively wide range. The mechanical power branch moreover facilitates a drive operation with especially high efficiency. In the case of the parallel connection of several such hydrodynamic torque converters, different torque converters can transmit power exclusively via the purely mechanical power branch. If the necessary total output of the fracturing pumps which are driven via the parallel torque converters is not an integer multiple of a fracturing pump driven with closed lock-up clutch, only a single torque converter has to transmit power hydrodynamically, that is via the hydrodynamic power branch—in order to achieve the necessary total volume flow of the various fracturing pumps. If possible, all parallel driven hydrodynamic torque converters can be operated with closed lock-up clutch to achieve maximum efficiency, wherein however, as a general rule, speed controllability of the at least one corresponding gas turbine is required in nominal operation.

The at least one fracturing pump has a delivery pressure for example of 130 bar to 1200 bar, in particular 500 bar to 1200 bar or more.

The flow rate is advantageously between 2 and 300 m³ per hour, in particular between 50 and 300 m³ per hour or more.

According to an optional embodiment of the present invention the hydrodynamic converter has a single bladed pump wheel and a single bladed turbine wheel and one or a number of bladed guide wheels, which are arranged in a common working medium circuit in a working chamber. For example, a first guide wheel with fixed guide blades and a second guide wheel with guide blades adjustable in the working medium circuit are provided in the working chamber.

The hydrodynamic converter is in particular the only hydrodynamic converter and in particular the only hydrodynamic machine in the hydrodynamic torque converter.

The input shaft is in particular in a drive connection via a toothed input stage with a first intermediate shaft, which carries the pump wheel, which is optionally provided with helical gearing and is formed, for example, by two intermeshing helical gears. The output shaft is in a drive connection—in particular via a toothed output stage which is advantageously provided with helical toothing and has, for example, two helical gears meshing with each other—with a second intermediate shaft which carries the turbine wheel. The first intermediate shaft can advantageously be mechanically coupled to the second intermediate shaft by way of the lock-up clutch.

The two intermediate shafts can optionally be arranged coaxially relative to one another. The input shaft and the output shaft are arranged, for example, parallel to one another and can also be arranged coaxially relative to one another.

Viewed in the direction of the drive power flow from the input shaft to the output shaft, both the input stage and the output stage optionally represent a speed reduction.

The hydraulic fracturing pump apparatus can, for example, be designed as a non-stationary hydraulic fracturing pump apparatus and for this purpose can include in particular a chassis, for example in the embodiment of a truck trailer with which it can be moved. In particular, a comparatively compact single-shaft gas turbine together with the hydrodynamic torque converter and a gas turbine can be mounted on a common conventional truck trailer with the usual permissible maximum dimensions for road traffic.

According to one embodiment of the present invention a plurality of parallel driven fracturing pumps are provided, each of which are in a driving connection with a separate gas turbine or with at least one common gas turbine. In each drive connection a hydrodynamic torque converter of the type described is accordingly provided per fracturing pump, and the torque converters are driven parallel to one another by the at least one gas turbine. In particular, a single gas turbine is provided, via which all fracturing pumps are driven parallel relative to one another.

The at least one gas turbine can for example be designed as a single-shaft gas turbine, having a constant nominal operating speed. According to another embodiment the at least one gas turbine is designed as a two-shaft gas turbine, having a variable nominal operating speed.

In a method according to the present invention for controlling a fracturing pump apparatus—with different specified total power outputs of all fracturing pumps driven in parallel to one another, in particular with different specified volume flows of the pressure medium to be conveyed, a maximum of one single hydrodynamic torque converter is always operated with an open lock-up clutch; and all other driven fracturing pumps are driven respectively via one hydrodynamic torque converter with respectively closed lock-up clutch. The at least one gas turbine is herein optionally operated at a constant nominal operating speed and can be designed accordingly as a single-shaft gas turbine.

In another method according to the present invention, which can be used in particular with at least one twin-shaft gas turbine as the prime mover of the fracturing pump apparatus—at different specified total power outputs of all fracturing pumps driven in parallel, in particular again at different specified total delivery volume flows—all driven fracturing pumps are driven respectively via a hydrodynamic torque converter with a closed lock-up clutch in each case, and an overall power adjustment is made by regulating or controlling the speed of the at least one prime mover. This allows efficiency losses to be minimized.

If, according to the previously discussed first embodiment of a method according to the present invention, four fracturing pumps, for example, are to meet a volume flow requirement of 320 percent, based on the maximum volume flow rate of a single one of the four fracturing pumps with the same maximum delivery volume, three fracturing pumps with mechanically switched hydrodynamic torque converters can each deliver 100 percent of their maximum delivery volume, for example, and the fourth fracturing pump can hydrodynamically controlled deliver 20 percent of its maximum delivery volume. This is achievable at constant input speed of all hydrodynamic torque converters. The losses from the hydrodynamic power transmission only occur in a single torque converter.

With variable input speed of the hydrodynamic torque converter, the same delivery volume can be achieved by mechanically shifting through all hydrodynamic torque converters and by operating the fracturing pumps at 80 percent of their maximum delivery volume. This makes further loss reductions possible. However, this requires the use of at least one gas turbine that can be speed-controlled in nominal operation.

### BRIEF DESCRIPTION OF THE DRAWINGS

The above-mentioned and other features and advantages of this invention, and the manner of attaining them, will become more apparent and the invention will be better understood by reference to the following description of embodiments of the invention taken in conjunction with the accompanying drawings, wherein:

FIG. 1 is a schematic representation of design example of a hydraulic fracturing pump apparatus;

FIG. 2 is an additional design example of a hydraulic fracturing pump apparatus with several fracture pumps.

Corresponding reference characters indicate corresponding parts throughout the several views. The exemplifications set out herein illustrate embodiments of the invention, and such exemplifications are not to be construed as limiting the scope of the invention in any manner.

### DETAILED DESCRIPTION OF THE INVENTION

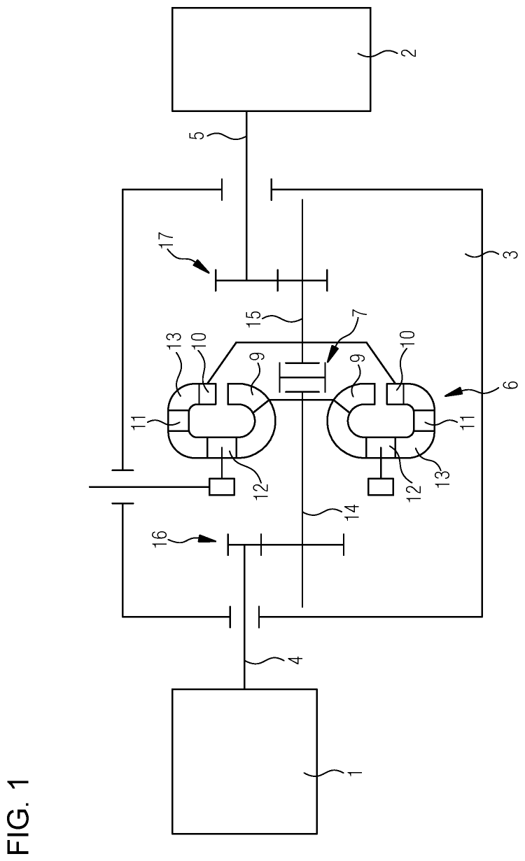

FIG. 1 illustrates a hydraulic fracturing pump apparatus, including a gas turbine 1 which drives a fracturing pump 2 via a hydrodynamic torque converter 3. Hydrodynamic torque converter 3 includes an input shaft 4 which is in a drive connection with a drive shaft of gas turbine 1, and an output shaft 5 which is in a drive connection with an input shaft of fracturing pump 2.

Hydrodynamic torque converter 3 includes two power branches, namely a first hydrodynamic power branch and a purely mechanical power branch arranged in parallel thereto in the power flow. The hydrodynamic power branch includes a hydrodynamic converter 6 and the mechanical power branch includes a lock-up clutch 7.

Hydrodynamic converter 6 has a pump wheel 9, which in the shown embodiment is supported by a first intermediate shaft 14, and a turbine wheel 10, which is supported by a second intermediate shaft 15. Pump wheel 9 and turbine wheel 10 are arranged in a common working chamber 13 together with a first guide wheel 11 and a second guide wheel 12. By driving pump wheel 9, a working medium circuit is established in working chamber 13, which hydrodynamically drives turbine wheel 10. The two guide wheels 11, 12 serve to adjust the change, i.e. the torque difference between the torque applied to pump wheel 9 and the torque applied to turbine wheel 10.

First guide wheel 11 is equipped with non-adjustable, that is fixed, guide blades, whereas second guide wheel 12 is equipped with guide blades adjustable in regard to a flow of the working medium in the working medium circuit.

The flow through pump wheel 9 and turbine wheel 10 occurs in particular centrifugally. The flow through pump wheel 9 can optionally also occur in diagonal-centrifugal direction.

First intermediate shaft 14 can be mechanically coupled to second intermediate shaft 15 by way of lock-up clutch 7, so that a purely mechanical drive connection can be established between input shaft 4, which is in mechanical drive connection with first intermediate shaft 14 via an input stage 16, and output shaft 5, which is in mechanical drive connection with second intermediate shaft 15 via an output stage 17.

According to one design example of the present invention, hydrodynamic torque converter 3 can transmit drive power exclusively via the hydrodynamic power branch or the mechanical power branch, and the parallel power transmission is excluded. According to an alternative embodiment, simultaneous power transmission via the hydrodynamic power branch and the mechanical power branch is possible, in particular the division of the power transmission can be variably adjusted.

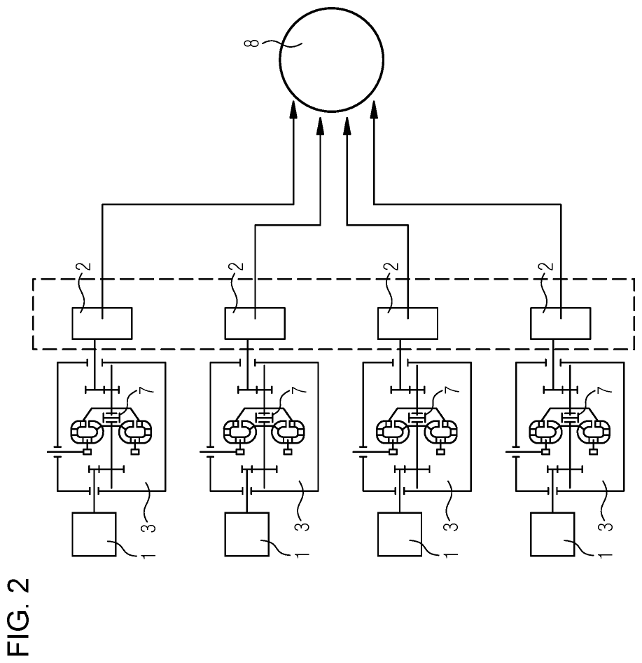

FIG. 2 shows an example of a hydraulic fracturing pump apparatus with four fracturing pumps 2, which together pump a pressure medium into a borehole 8 to a predetermined rock layer. The number four is exemplary and, of course, a different number of fracturing pumps 2 may be provided. A total flow rate and a total pressure are specified for all fracturing pumps 2 combined, as indicated by the dashed line. For this purpose, fracturing pumps 2 are each driven via a hydrodynamic torque converter 3 of the type shown previously by way of one or more common gas turbines 1 or, in this case, each with its own gas turbine 1 in order to achieve the desired total volume flow and delivery pressure. Of course, hydrodynamic torque converters 3 could also be designed differently from the details shown previously.

Different fracturing pumps 2 are optionally driven in such a way that as many hydrodynamic torque converters 3 as possible operate with closed lock-up clutch 7. In particular, only one torque converter 3 operates with an open lock-up clutch 7. According to one embodiment, all torque converters operate with a closed lock-up clutch 7 and the speed of fracturing pumps 2 is set via the drive speed of gas turbine 1 or more specifically, respective gas turbine 1.

### COMPONENT IDENTIFICATION LISTING

1 Gas turbine
2 Fracturing pump
3 Hydrodynamic torque converter
4 Input shaft
5 Output shaft
6 Hydrodynamic converter
7 Lock-up clutch
8 Bore hole
9 Pump wheel
10 Turbine wheel
11 Guide wheel
12 Guide wheel
13 Working chamber
14 First intermediate shaft
15 Second intermediate shaft
16 Input stage
17 Output stage

While this invention has been described with respect to at least one embodiment, the present invention can be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains and which fall within the limits of the appended claims.

What is claimed is:

1. A hydraulic fracturing pump apparatus, comprising:
at least one gas turbine forming a prime mover and including at least one of a single-shaft gas turbine and a multi-shaft gas turbine;
at least one fracturing pump which is in a drive connection with the at least one gas turbine to be driven by way of the at least one gas turbine and which is configured for pumping a pressure medium into a rock layer; and
a hydrodynamic torque converter in the drive connection, the hydrodynamic torque converter including an input shaft, an output shaft, and a hydrodynamic converter, the input shaft being switchable via the hydrodynamic converter into a hydrodynamic drive connection with the output shaft.

2. The hydraulic fracturing pump apparatus according to claim 1, wherein the hydrodynamic torque converter moreover includes a switchable lock-up clutch, and the input shaft is switchable via the lock-up clutch into a purely mechanical drive connection with the output shaft.

3. The hydraulic fracturing pump apparatus according to claim 2, wherein the at least one fracturing pump has a delivery pressure of one of 130 bar to 1200 bar and 500 bar to at least 1200 bar.

4. The hydraulic fracturing pump apparatus according to claim 3, wherein the at least one fracturing pump has a flow rate of one of 2 to 300 m³ per hour and between 50 and at least 300 m³ per hour.

5. The hydraulic fracturing pump apparatus according to claim 4, wherein the hydrodynamic converter includes a single bladed pump wheel, a single bladed turbine wheel, at least one bladed guide wheel, and a working chamber, the single bladed pump wheel, the single bladed turbine wheel, and the at least one bladed guide wheel being arranged in a common working medium circuit in the working chamber.

6. The hydraulic fracturing pump apparatus according to claim 5, wherein the at least one bladed guide wheel includes a first guide wheel and a second guide wheel in the working chamber, the first guide wheel including a plurality of fixed guide blades, the second guide wheel including a plurality of guide blades adjustable in the common working medium circuit.

7. The hydraulic fracturing pump apparatus according to claim 6, further comprising a toothed input stage with a helical toothing, a toothed output stage with a helical gearing, a first intermediate shaft, and a second intermediate shaft, the input shaft being in a drive connection via the toothed input stage with the first intermediate shaft which carries the single bladed pump wheel, the output shaft being in a drive connection via the toothed output stage with the second intermediate shaft which carries the single bladed turbine wheel, and the first intermediate shaft being configured for being coupled mechanically to the second intermediate shaft by way of the switchable lock-up clutch.

8. The hydraulic fracturing pump apparatus according to claim 7, wherein, viewed in a direction of a drive power flow from the input shaft to the output shaft, the toothed input stage as well as the toothed output stage represent a speed reduction.

9. The hydraulic fracturing pump apparatus according to claim 1, wherein the hydraulic fracturing pump apparatus is configured for being moved by way of a chassis formed as a truck trailer.

10. The hydraulic fracturing pump apparatus according to claim 1, wherein the at least one fracturing pump includes a plurality of the fracturing pump driven parallel to one another, each of which are in a driving connection with one of a respective one of a plurality of the gas turbine and a common one of the at least one gas turbine, wherein in each one of the driving connection per the fracturing pump a corresponding one of the hydrodynamic torque converter is provided resulting in a plurality of the hydrodynamic torque converter, the plurality of the hydrodynamic torque converter being driven parallel to one another by a respective one of the at least one gas turbine.

11. The hydraulic fracturing pump apparatus according to claim 1, wherein the at least one gas turbine is designed as the single-shaft gas turbine, having a constant nominal operating speed.

12. The hydraulic fracturing pump apparatus according to claim 1, wherein the at least one gas turbine is designed as a two-shaft gas turbine, having a variable nominal operating speed.

13. A method for controlling a fracturing pump apparatus, the method comprising the steps of:
providing that the fracturing pump apparatus is a hydraulic fracturing pump apparatus including:
at least one gas turbine forming a prime mover and including at least one of a single-shaft gas turbine and a multi-shaft gas turbine;
at least one fracturing pump which is in a drive connection with the at least one gas turbine to be driven by way of the at least one gas turbine and which is configured for pumping a pressure medium into a rock layer; and
at least one hydrodynamic torque converter in the drive connection, the at least one hydrodynamic torque converter including an input shaft, an output shaft, and a hydrodynamic converter, the input shaft being switchable via the hydrodynamic converter into a hydrodynamic drive connection with the output shaft, the at least one fracturing pump including a plurality of the fracturing pump driven parallel to one another, each of which are in a driving connection with one of a respective one of a plurality of the gas turbine and a common one of the at least one gas turbine, wherein in each one of the driving connection per the fracturing pump a corresponding one of the hydrodynamic torque converter is provided resulting in a plurality of the hydrodynamic torque converter, the plurality of the hydrodynamic torque converter being driven parallel to one another by a respective one of the at least one gas turbine; and
driving the plurality of the fracturing pump in parallel to one another with different specified total power outputs of all the plurality of the fracturing pump, such that always only a maximum of a single one of the at least one hydrodynamic torque converter is operated with an open lock-up clutch and all other ones of the plurality of the fracturing pump are driven respectively via a respective one of the at least one hydrodynamic torque converter with respectively a closed lock-up clutch.

14. The method according to claim 13, wherein the at least one gas turbine is operated at a constant nominal operating speed.

15. A method for controlling a fracturing pump apparatus, the method comprising the steps of:
providing that the fracturing pump apparatus is a hydraulic fracturing pump apparatus including:
at least one gas turbine forming a prime mover and including at least one of a single-shaft gas turbine and a multi-shaft gas turbine;
at least one fracturing pump which is in a drive connection with the at least one gas turbine to be driven by way of the at least one gas turbine and which is configured for pumping a pressure medium into a rock layer; and
at least one hydrodynamic torque converter in the drive connection, the at least one hydrodynamic torque converter including an input shaft, an output shaft, and a hydrodynamic converter, the input shaft being switchable via the hydrodynamic converter into a hydrodynamic drive connection with the output shaft, the at least one fracturing pump including a plurality of the fracturing pump driven parallel to one another, each of which are in a driving connection with one of a respective one of a plurality of the gas turbine and a common one of the at least one gas turbine, wherein in each one of the driving connection per the fracturing pump a corresponding one of the hydrodynamic torque converter is provided resulting in a plurality of the hydrodynamic torque converter, the plurality of the hydrodynamic torque converter being driven parallel to one another by a respective one of the at least one gas turbine;
driving respectively, for different specified total power outputs, all driven ones of the plurality of the fracturing pump via a respective one of the at least one hydrodynamic torque converter with a respectively closed lock-up clutch; and
adjusting a speed of the at least one gas turbine and thereby setting an actual total power output of the plurality of the fracturing pump.

16. The method according to claim 15, wherein the at least one gas turbine is operated at a variable nominal operating speed.
